(19) United States
(12) Patent Application Publication
(10) Pub. No.: US 2004/0004089 A1
(43) Pub. Date: Jan. 8, 2004

(54) Cover for water dispenser bottle

(76) Inventor: Angela P. Petty, Chesapeake, VA (US)

Correspondence Address: Blackmon IPS & Law Office, PMB#289, 2101 Crystal Plaza Arcade, Arlington, VA, 22202, US

(21) Appl. No.: 10/188,864

(22) Filed: Jul. 5, 2002

(51) Int. Cl. B67D 5/06

(52) U.S. Cl. 222/185.1

(57) ABSTRACT

A cover for the supply bottle of a liquid dispenser such as a water dispenser. The cover is generally cylindrical and open at the bottom. The cover has a generally circular upper panel and a depending panel. The depending panel has a full length open seam, and is joined continuously to the upper panel along the circumference of the latter. The open seam defines opposed edges. The cover is preferably fabricated from fabric which is folded over to provide double thickness at the opposed edges. The opposed edges bear hook and loop fastener which overlies and does not extend beyond the double thickness of the opposed edges. The cover fits in close cooperation over generally cylindrical supply bottles and fully cover the latter when installed in operable inverted position in a liquid dispenser.

### BACKGROUND OF THE INVENTION

1. Field of the Invention

The present invention relates to covers, and more particularly to a flaccid cover for a supply bottle of a water dispenser.

2. Description of the Prior Art

Water dispensers, particularly for drinking water, have become popular appliances in occupied spaces of buildings. A water dispenser may be permanently connected to the building and to its plumbing system, or alternatively may be independent. The independent form may have an electrical connection by a manually removable plug and cord, for appliances having liquid cooling and heating capabilities, or, in the absence of such capabilities, may be entirely independent of connection to the building. Drinking water dispensers usually utilize large supply bottles of potable water, placed inverted on the dispenser so that water will flow into the dispensing circuit under the influence of gravity. Water supply bottles may be unsightly, exhibiting dirt and scuff marks, or may be subject to collecting dust and other environmental contaminants if not covered. There exists a need for an inexpensive, practical cover for supply bottles of water for water dispensers.

### SUMMARY OF THE INVENTION

The present invention provides an inexpensive, practical cover for supply bottles of water for water dispensers. The novel cover is preferably of fabric, fitting in close cooperation with a supply bottle and being readily installed thereon and removed therefrom. The cover has a circular upper panel, a depending panel or skirt split to form a vertical seam, and hook and loop closure enabling the vertical seam to be joined, thereby closing the depending panel over the supply bottle. The novel cover conceals the entire bottle from view when installed, thereby achieving both a desired aesthetic effect and sanitary protection of the supply bottle.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a side elevational view of the novel cover installed on a water bottle which in turn has been installed in a water dispenser.

FIG. 2 is an enlarged, perspective view of the cover of FIG. 1.

### DETAILED DESCRIPTION OF THE PREFERRED EMBODIMENTS

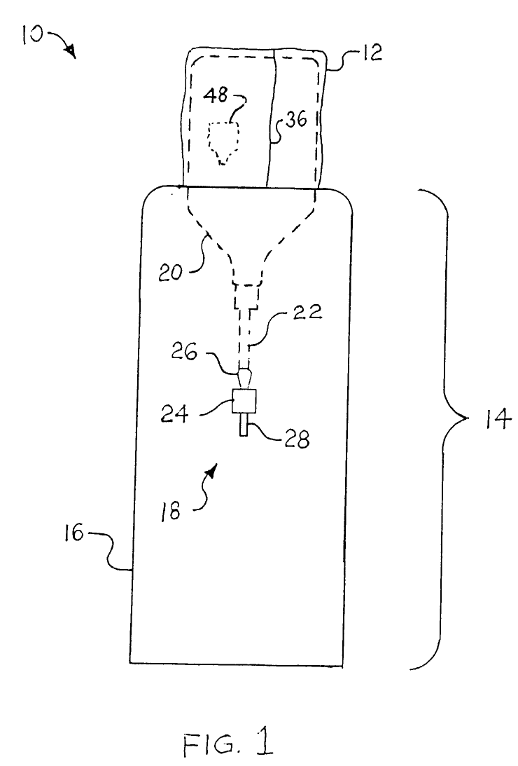

Turning now to FIG. 1 of the drawings, there is shown a water dispenser 10 having an associated cover 12. Dispenser 10 comprises a water dispenser component 14 having a body 16 and a tap 18 disposed on body 16. A generally cylindrical receptacle such as water bottle 20 is installed on body 16. It will be understood that as employed herein, generally cylindrical corresponds to the dominant visual impression of bottle 20, certain variations in configuration notwithstanding. For example, many water bottles have shallow circumferential ribs (not shown) which do not alter the overall visual impression of the receptacle of the bottle as being cylindrical. Similarly, the closed end of the bottle may be dished inwardly or outwardly (neither shown) without affecting the overall impression of the cylindrical nature of the bottle. Also, the neck of the bottle may vary in diameter and configuration where it joins the receptacle of the bottle. The end of the bottle at the neck may be generally frustoconical as shown or may otherwise depart from a pure cylindrical configuration. Bottle 20 may have a handle or other structure (none shown) molded into the receptacle or end thereof. Cylindrical configuration of bottle 20 will be understood to encompass any one or more of these departures from purely cylindrical configuration.

Cover 12 is for covering bottle 20. Body 16 is arranged such that bottle 20 is capable of being supported on and, in the absence of cover 12, exposed at the upper end of body 16. Body 16 is a structural member which supports bottle 20 and houses operating components of-water dispenser 10. The operating components will be understood to include an internal water conduit 22 arranged to conduct water from bottle 20, when installed, to tap 18. Tap 18 preferably has a valve 24 operated by a lever 26, and a nozzle 28 for discharging water from bottle 20 when valve 24 is open. Bottle 20 is concealed from view by cover 12.

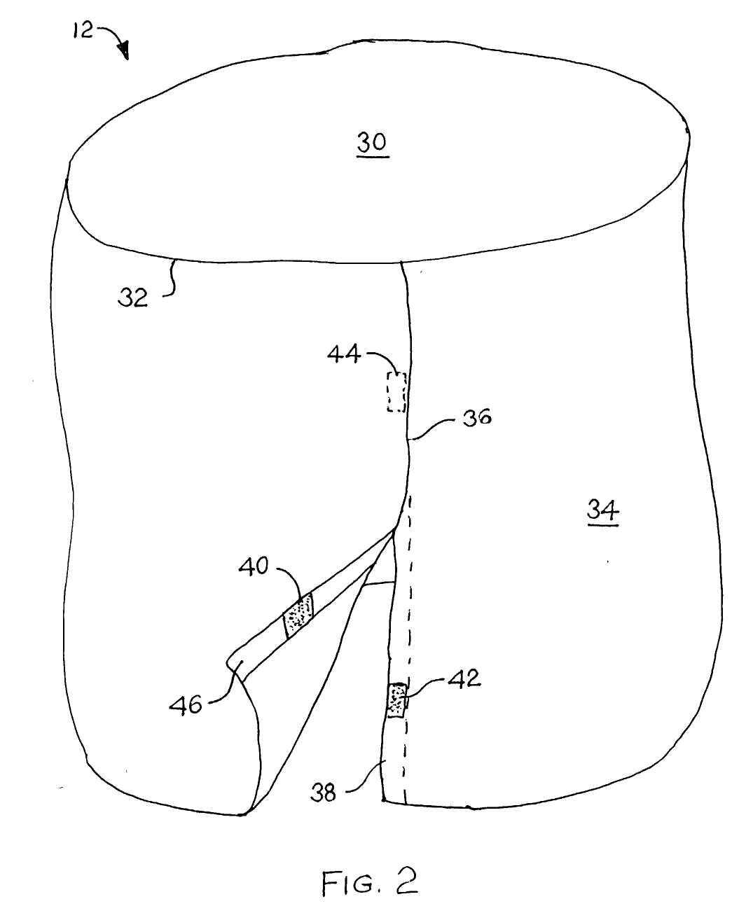

FIG. 2 shows details of construction of cover 12, which comprises an upper panel 30 having a circular circumference 32 closely matching that of bottle 20. A depending panel 34 extends perpendicularly from upper panel 30, and is joined continuously to upper panel 30 at circumference 32. In the preferred embodiment, cover 12 is fabricated from a woven fabric, and thus is flexible, flaccid, and to a degree opaque. It will be understood that as employed herein, opaque signifies that bottle 20 is not visible through the constituent fabric material of cover 12 in the absence of strong backlighting, even though woven fabrics contain minute openings through which some light may pass. Fabric is washable and superior in appearance to other flexible, flaccid materials such as plastics, and furthermore is less subject to become dry and stiff. It will be further understood that continuous joining of upper panel 30 to depending panel 34 encompasses stitching and other constructions wherein fastening materials are provided periodically but not in contact with one another.

An open vertical seam formed in depending panel 34 defines a first edge 36 of depending panel 34 and also an opposed second edge 38 arranged to overlap first edge 36. While it is not strictly necessary to the invention, it is preferred that the vertical seam extend the full length of depending panel 34.

Depending panel 34 is depicted with one corner shown in a lifted position to reveal detail of its reverse side. A suitable fastener such as hook and loop material is provided on edges 36, 38. Preferably, complementing patches 40, 42 of hook and loop material are affixed to panel 34 at suitable spaced apart locations along edges 36, 38. A second pair of complementing patches, indicated collectively as 44, is shown in overlying, mated condition. Edge 36 is thereby releasably attached to edge 38, so that depending panel 34 may be suitably expanded to slip readily over bottle 20, and to be removed therefrom.

The constituent fabric of depending panel 34 is folded over to double thickness, as shown at 46, and is stitched to maintain edge 36 neat, straight, and capable of resisting unraveling. Edge 38 also is folded over to double thickness and is stitched. Preferably, patches of hook and loop material 40, 42, 44 are dimensioned, configured, and located so as to overlie only the double thickness portion of edges 36, 38.

Referring again to FIG. 1, depending panel 34 bears upon its exterior side a graphic representation 48 of a generally cylindrical receptacle having a neck. The receptacle represented thereby is depicted such that the relatively small neck of the receptacle of the graphic representation is located on that side of depending panel 34 opposite upper panel 30. In this way, representation 48 graphically suggests appropriate orientation of cover 12 relative to bottle 20. Representation 48 could also include printed instructions (not shown), if desired.

In the preferred embodiment, depending panel 34 has length oriented perpendicularly from upper panel 30. Alternatively stated, the length of cover 12 is oriented along depending panel 34, and its magnitude is greater than that of the diameter of upper panel 30.

The graphic representation may take any convenient form. For example, it may be one or more dies, pigments, or other substances deposited on or impregnated into the fabric. It may be bleach or other chemical based treatment of the fabric. It may be formed by energy such as light or heat. It may be a decal, patch, or stitching affixed to the fabric.

Preferably, cover 12 consists only of upper panel 30 and depending panel 34, with no external ancillary elements such as pockets, handles, and other projecting structure which could trap dust, unravel, or otherwise impair the appearance of cover 12, although the graphic representation must be regarded as an optional component of depending panel 34. Where constructed from woven fabric, cover 12 will be understood to include seam structure and stitching or other fastening for joining upper panel 30 to depending panel 34.

The invention is susceptible to variations and modifications which may be introduced thereto without departing from the inventive concept. For example, any type of liquid may be dispensed, not only water. Also, the exact nature of the dispenser may vary from that described in function and structure. The dispenser may be manually operated or alternatively, electrically operated. The dispenser may be combined with apparatus for accomplishing additional functions. The invention may be applied to devices having plural liquid dispensing bottles, such as fluid concentrate dispensers for preparing differently flavored beverages.

It is to be understood that the present invention is not limited to the embodiments described above, but encompasses any and all embodiments within the scope of the following claims.

I claim:

1. A cover for a generally cylindrical receptacle, comprising a flexible, flaccid, opaque upper panel having a circular circumference, and a depending flexible, flaccid, opaque depending panel extending perpendicularly from said upper panel and joined continuously to said upper panel at said circumference, an open vertical seam extending the full length of said depending panel, said vertical seam forming a first edge of said depending panel and an opposed, overlapping second edge of said depending panel, and hook and loop fastener material disposed upon said first edge of said depending panel and upon said second edge of said depending panel so as to attach said first edge of said depending panel releasably to said second edge of said depending panel.

2. The cover according to claim 1, further comprising a graphic representation of a generally cylindrical receptacle having a neck, disposed upon the exterior of said depending panel of said cover such that said neck of said graphic representation is depicted on that side of said depending panel opposite to said upper panel.

3. The cover according to claim 1, wherein said upper panel and said depending panel each are made from woven fabric, said fabric of said first edge of said depending panel is folded to double thickness, said fabric of said second edge of said depending panel is folded to double thickness, and said hook and loop material overlies only said first edge of said depending panel and said second edge of said depending panel.

4. A liquid dispenser and an associated cover therefor, comprising:
a liquid dispenser component having a body and a tap disposed on said body;
a generally cylindrical liquid supply receptacle dimensioned and configured to be supported on and exposed at the upper end of said body of said liquid dispenser; and
a cover for said liquid supply receptacle, comprising a flexible, flaccid, opaque upper panel having a circular circumference, and a depending flexible, flaccid, opaque depending panel extending perpendicularly from said upper panel and joined continuously to said upper panel at said circumference, wherein said depending panel has length oriented perpendicularly from said upper panel, an open vertical seam extending the full length of said depending panel, said vertical seam forming a first edge of said depending panel and an opposed, overlapping second edge of said depending panel, and hook and loop fastener material disposed upon said first edge of said depending panel and upon said second edge of said depending panel so as to attach said first edge of said depending panel releasably to said second edge of said depending panel, wherein said cover is dimensioned and configured to fit in close cooperation with said liquid supply receptacle and to cover said liquid supply receptacle from view when said liquid supply receptacle is installed on said body of said liquid dispenser.
